(19) United States
(12) Patent Application Publication
(10) Pub. No.: US 2015/0287353 A1
(43) Pub. Date: Oct. 8, 2015

(54) ORGANIC LIGHT EMITTING DISPLAY DEVICE AND METHOD FOR DRIVING THE SAME

(71) Applicant: SAMSUNG DISPLAY CO., LTD., Yongin-City (KR)

(72) Inventors: Jae Woo Song, Anyang-si (KR); Jae Hoon Lee, Seoul (KR); Do Hyung Ryu, Yongin-si (KR); Hae Goo Jung, Yongin-si (KR)

(21) Appl. No.: 14/464,674

(22) Filed: Aug. 20, 2014

(30) Foreign Application Priority Data
Apr. 2, 2014 (KR) 10-2014-0039386

(51) Int. Cl. G09G 3/20; G09G 3/32

(52) U.S. Cl. CPC G09G 3/2022; G09G 3/3258; G09G 2310/027; G09G 2310/08; G09G 2320/0646

(57) ABSTRACT

An organic light emitting display device is configured to divide one frame into a plurality of sub-frames and to express gradations based on a sum of light emitting times of the plurality of sub-frames, the organic light emitting display device includes: a driving unit configured to provide at least two on-voltages having different voltage values; and a display unit comprising a plurality of organic light emitting elements configured to be driven by the on-voltages.

### CROSS-REFERENCE TO RELATED APPLICATION

This application claims priority to and the benefit of Korean Patent Application No. 10-2014-0039386, filed on Apr. 2, 2014 in the Korean Intellectual Property Office, the disclosure of which is incorporated herein in its entirety by reference.

### BACKGROUND

1. Field

Aspects of embodiments of the present invention relate to an organic light emitting display device and a method for driving the same.

2. Description of the Related Art

Recently, as demand has increased for electronic devices that are miniaturized and generally consume less power, organic light emitting display devices have widely been used. In general, an organic light emitting display device displays gradation (in an analog drive format) using a voltage stored in a storage capacitor that is included in each pixel. However, in the analog drive format, the gradation is expressed on the basis of the voltage stored in the storage capacitor, and thus it may be relatively difficult to accurately express desired gradation.

In order to solve this problem, it has been attempted to apply a digital drive configuration to an organic light emitting display device. According to the digital drive configuration of the organic light emitting display device, one frame may be divided into a plurality of sub-frames to be displayed. That is, one frame may be divided into a plurality of sub-frames, light emitting times of the sub-frames may be differently set in the ratio of 2̂n, and a gradation (e.g., a specific gradation) may be expressed on the basis of the sum of the light emitting times.

### SUMMARY

Aspects of example embodiments of the present invention include a digital drive configuration organic light emitting display device and a method for driving the same.

A data voltage may be charged in each sub-frame by a scan signal. As an organic light emitting display device has a larger area, higher resolution, and higher picture quality, a larger number of sub-frames may be required in one frame. Due to the increase of the number of sub-frames, time required to once scan the sub-frames may be gradually decreased, and thus the data voltage may not be sufficiently charged in each pixel, which may deteriorate the display quality.

Accordingly, embodiments of the present invention may operate to provide an organic light emitting display device, which can extend gradation expressions without increasing the number of sub-frames.

Embodiments of the present invention may also operate to provide a method for driving an organic light emitting display device, which can extend gradation expressions without increasing the number of sub-frames.

Additional aspects, subjects, and features of the invention will be set forth in part in the description which follows and in part will become apparent to those having ordinary skill in the art upon examination of the following or may be learned from practice of the invention.

According to aspects of embodiments of the present invention, an organic light emitting display device is configured to divide one frame into a plurality of sub-frames and to express gradations based on a sum of light emitting times of the plurality of sub-frames, the organic light emitting display device including: a driving unit configured to provide at least two on-voltages having different voltage values; and a display unit including a plurality of organic light emitting elements configured to be driven by the on-voltages.

The driving unit may be configured to provide: a first on-voltage configured to cause the organic light emitting elements to emit light with a first luminance; and a second on-voltage configured to cause the organic light emitting elements to emit light with a second luminance lower than the first luminance.

The first luminance may be twice the second luminance.

The first on-voltage may be a gate voltage that corresponds to a saturation region of a thin film transistor, and the second on-voltage may be a gate voltage that corresponds to a linear region of the thin film transistor.

A minimum control gradation of the first on-voltage may be twice a minimum control gradation of the second on-voltage.

The organic light emitting element may include a first thin film transistor configured to drive the organic light emitting element and a second thin film transistor configured to control the first thin film transistor, and wherein the on-voltage may be applied to a gate terminal of the first thin film transistor through the second thin film transistor.

The light emitting times of the plurality of sub-frames may be different from each other in the ratio of 2̂n.

The driving unit may include a data driving unit configured to provide the on-voltage to the display unit, a scan driving unit configured to provide a scan signal to the display unit, and a timing control unit configured to control the data driving unit and the scan driving unit, and the organic light emitting display device may further include a voltage generation unit configured to provide a gray reference voltage to the data driving unit and to provide a first voltage and a second voltage to the display unit.

The timing control unit may further include a data control unit configured to analyze video data, to output a voltage control signal to the voltage generation unit, and to control the gray reference voltage, and the data driving unit may be configured to determine a voltage value of the on-voltage corresponding to the gray reference voltage.

According to aspects of embodiments of the present invention, an organic light emitting display device is configured to divide one frame into a plurality of sub-frames and to express gradations based on a sum of light emitting times of the plurality of sub-frames, the organic light emitting display device including: a driving unit configured to provide at least two on-voltages having different voltage values according to input video data; and a display unit including a plurality of organic light emitting elements that are configured to be driven by the on-voltages.

The driving unit may include a mode setting unit configured to discriminate a first mode from a second mode according to the video data, and the driving unit may be configured to provide a first on-voltage corresponding to a first luminance in the first mode, and to provide a second on-voltage corresponding to a second luminance lower than the first luminance in the second mode.

The first mode may correspond to normal driving and the second mode may correspond to 3D driving or dual-view driving.

The organic light emitting display device may further include a voltage generation unit configured to provide a gray reference voltage to the driving unit and to provide a first voltage and a second voltage to the display unit.

The mode setting unit may be configured to provide a first mode signal or a second mode signal to the voltage generation unit, and the voltage generation unit may be configured to output a first gray reference voltage corresponding to the first mode signal to the driving unit and to output a second gray reference voltage corresponding to the second mode signal to the driving unit.

The first luminance may be twice the second luminance.

According to aspects of embodiments of the present invention, in a method for driving an organic light emitting display device, the organic light emitting display device is configured to divide one frame into a plurality of sub-frames and to express gradations based on a sum of light emitting times of the plurality of sub-frames, the method including: analyzing video data; outputting a voltage control signal; outputting a gray reference voltage corresponding to the voltage control signal; outputting an on-voltage that corresponds to the vide data based on the gray reference voltage; and emitting light corresponding to the on-voltage by organic light emitting elements, wherein the on-voltage has at least two different voltage values.

The on-voltage may include a first on-voltage configured to cause the organic light emitting elements to emit light with a first luminance and a second on-voltage configured to cause the organic light emitting elements to emit light with a second luminance lower than the first luminance.

The outputting of the voltage control signal may include setting a first mode and a second mode that are discriminated from each other according to the video data, and outputting a first mode signal or a second mode signal corresponding to the set mode.

The outputting of the gray reference voltage may include outputting a first gray reference voltage corresponding to the first mode signal, and outputting a second gray reference voltage corresponding to the second mode signal.

The outputting of the on-voltage may include outputting a first on-voltage corresponding to the first mode, and outputting a second on-voltage corresponding to the second mode.

According to some embodiments of the present invention, Because various gradations can be expressed, display quality of an organic light emitting display device may be improved.

Aspects of embodiments of the present invention are not limited to the contents as illustrated above, but further various aspects are included in the description.

### BRIEF DESCRIPTION OF THE DRAWINGS

The above and other characteristics, features, and aspects of the present invention will be more apparent from the following detailed description taken in conjunction with the accompanying drawings, in which:

FIG. 1 is a block diagram of an organic light emitting display device according to an embodiment of the present invention;

FIG. 2 is a circuit diagram of a pixel according to an embodiment of the present invention;

FIG. 3 is a schematic diagram illustrating a plurality of sub-frames;

FIG. 4 is a graph illustrating the driving characteristics of a first thin film transistor;

FIG. 5 is a schematic diagram illustrating the relationship between a first on-voltage and luminance of an organic light emitting element;

FIG. 6 is a schematic diagram illustrating the relationship between a second on-voltage and luminance of an organic light emitting element;

FIG. 7 is a block diagram of a timing control unit according to an embodiment of the present invention;

FIG. 8 is a block diagram of a data control unit according to an embodiment of the present invention;

FIG. 9 is a block diagram of a voltage generation unit according to an embodiment of the present invention;

FIG. 10 is a block diagram of a data driving unit according to an embodiment of the present invention;

FIG. 11 is a block diagram of an organic light emitting display device according to another embodiment of the present invention;

FIG. 12 is a block diagram of a timing control unit according to another embodiment of the present invention;

FIG. 13 is a block diagram of a voltage generation unit according to another embodiment of the present invention;

FIG. 14 is a flowchart of a method for driving an organic light emitting display device according to an embodiment of the present invention; and

FIG. 15 is a flowchart of a process of outputting a voltage control signal according to an embodiment of the present invention.

### DETAILED DESCRIPTION

Aspects and features of some embodiments of the present invention will be apparent by referring to the embodiments to be described in some detail with reference to the accompanying drawings. However, embodiments of the present invention are not limited to the embodiments disclosed hereinafter, but can be implemented in diverse forms. The matters defined in the description, such as the detailed construction and elements, are example details provided to assist those of ordinary skill in the art in a more comprehensive understanding of the invention, and the present invention is only defined within the scope of the appended claims, and their equivalents.

The term “on” that is used to designate that an element is on another element or located on a different layer includes both a case where an element is located directly on another element or a layer and a case where an element is located on another element via another layer or still another element. In the entire description of the present invention, the same drawing reference numerals are used for the same elements across various figures.

Although the terms “first,” “second,” and so forth are used to describe diverse constituent elements, such constituent elements are not limited by the terms. The terms are used only to distinguish a constituent element from other constituent elements. Accordingly, in the following description, a first constituent element may be a second constituent element.

Hereinafter, example embodiments of the present invention will be described in some detail with reference to the accompanying drawings.

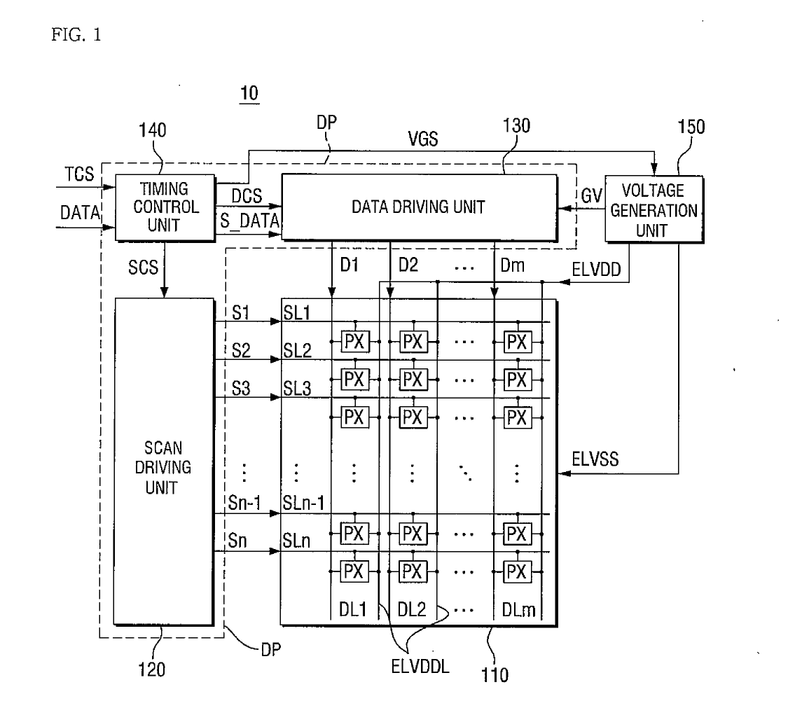

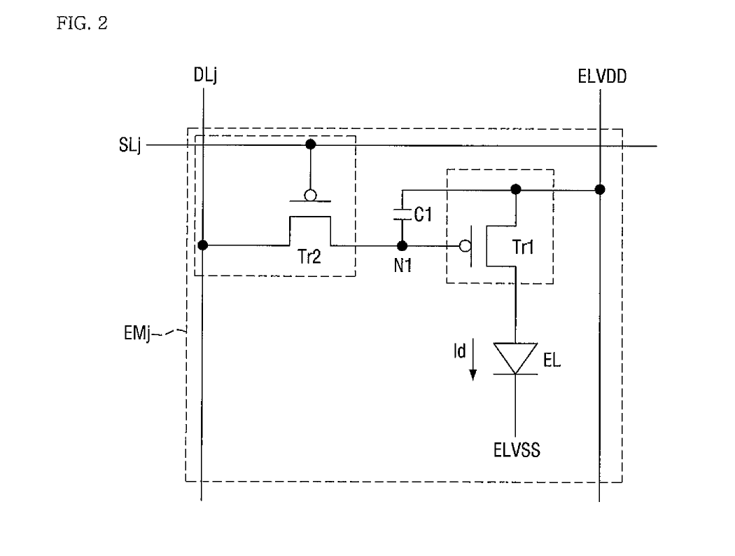

FIG. 1 is a block diagram of an organic light emitting display device according to an embodiment of the present invention, and FIG. 2 is a circuit diagram of a pixel according to an embodiment of the present invention.

Referring to FIGS. 1 and 2, an organic light emitting display device 10 includes a display unit 110 and a driving unit DP.

The display unit 110 may be a region where an, image is displayed, and the driving unit DP may drive the display unit 110. The display unit 110 may include a plurality of scan lines SL1 to SLn, a plurality of data lines DL1 to DLm that cross the plurality of scan lines SL1 to SLn, and a plurality of pixels PX each of which is coupled to one of the plurality of scan lines SL1 to SLn and one of the plurality of data lines DL1 to DLm. The plurality of scan lines SL1 to SLn may be shaped to extend in a first direction D1, and may be substantially in parallel to each other. The plurality of scan lines SL1 to SLn may include first to n-th scan lines SL1 to SLn that are arranged in order. The plurality of data lines DL1 to DLm may cross the plurality of scan lines SL1 to SLn. That is, the plurality of data lines DL1 to DLm may be shaped to extend in a second direction D2 that is perpendicular to the first direction D1, and may be substantially in parallel to each other. Here, the first direction D1 may correspond to a row direction, and the second direction D2 may correspond to a column direction. Data voltages D1 to Dm may be respectively applied to the plurality of data lines DL1 to DLm.

The plurality of pixels PX may be arranged in a matrix form, but are not limited thereto. Each of the plurality of pixels PX may be coupled to one of the plurality of scan lines SL1 to SLn and one of the plurality of data lines DL1 to DLm. The plurality of pixels PX may receive the data voltages D1 to Dm that are applied to the data lines DL1 to DLm corresponding to scan signals S1 to Sn provided from the scan lines SL1 to SLn. Further, the plurality of pixels PX may be coupled to a first power line ELVDDL to receive a first power voltage ELVDD, and may receive a second power voltage ELVSS through a second power line.

Here, each of the plurality of pixels PX may include at least one organic light emitting element EM.

As illustrated in FIG. 2, the j-th organic light emitting element EMj may include a first thin film transistor Tr1 and a second thin film transistor Tr2. However, this is merely an example embodiment, and the configuration of the organic light emitting element is not limited to that as illustrated in FIG. 2. Here, the j-th organic light emitting element EMj may be an organic light emitting element included in any one PXj of the plurality of pixels PX. The first thin film transistor Tr1 may drive the j-th organic light emitting element EMj, and the second thin film transistor Tr2 may control the first thin film transistor Tr1. Here, a gate terminal of the second thin film transistor Tr2 may be coupled to the j-th scan line SLj, a source terminal of the second thin film transistor Tr2 may be coupled to the j-th data line DLj, and a drain terminal of the second thin film transistor Tr2 may be coupled to a first node N1. The second thin film transistor Tr2 may be turned on by the scan signal Sj that is applied to the j-th scan line SLj to be conducted with the j-th data line DLj. Here, data voltage Dj may be applied through the j-th data line DLj. The data voltage Dj may move from the source terminal of the second thin film transistor Tr2 to the first node N1 of the drain terminal, and may be transferred to a first capacitor C1 and a gate terminal of the first thin film transistor Tr1. That is, the electric potential of the data voltage Dj and the electric potential of the first capacitor C1 and the first thin film transistor Tr1 may be equal to each other.

One end of the first capacitor C1 may be coupled to the first node N1, and the other end thereof may be coupled to the first power line ELVDDL. If the second thin film transistor Tr2 is in an off state (unselected state), the first capacitor C1 may store the gate voltage of the first thin film transistor Tr1.

The gate terminal of the first thin film transistor Tr1 may be coupled to the first node N1, the first power voltage ELVDD may be input to the source terminal of the first thin film transistor Tr1, and the drain terminal of the first thin film transistor Tr1 may be coupled to one end of the organic light emitting element EM. The other end of the organic light emitting element EM may be coupled to the second power voltage ELVSS. The first power voltage ELVDD may be a driving voltage, and the second voltage ELVSS may be a base voltage such as a ground voltage. The amount of current Id that flows through a channel of the first thin film transistor Tr1 may be determined according to the electric potential difference between the first power voltage ELVDD and the data voltage Dj, and the amount of light emitted from the organic light emitting element EM may be determined according to the amount of current Id.

Here, the data voltages D1 to Dm may be on-voltages that drive the corresponding organic light emitting elements EM to emit light or off-voltages that turn off the organic light emitting elements EM.

The off-voltage corresponds to a voltage at which the electric potential of the gate terminal of the first thin film transistor Tr1 is higher than a threshold electric potential Vth, and the organic light emitting element EM may not emit light if the data voltages D1 to Dm are off-voltages.

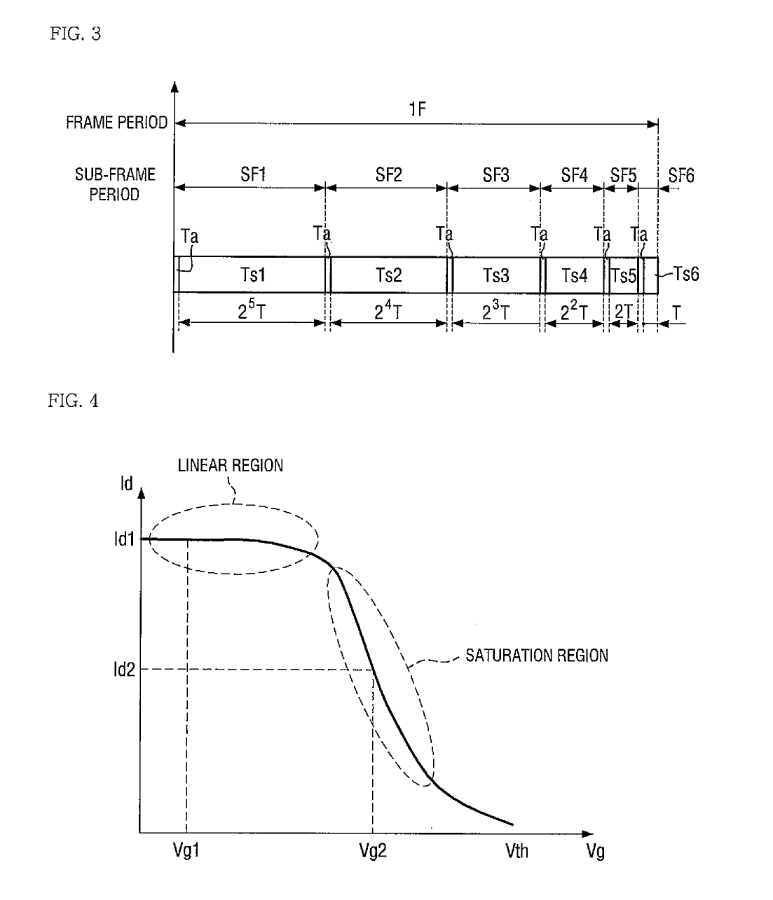

The on-voltage corresponds to a voltage at which the electric potential of the gate terminal of the first thin film transistor Tr1 is lower than the threshold electric potential Vth. Here, the on-voltage and the off-voltage may be defined in the opposite manner to that as described above depending on the characteristics of the thin film transistor. The on-voltage may be a constant voltage having a constant value. That is, the organic light emitting display device 10 according to this embodiment may correspond to digital driving to apply a constant on-voltage. In this case, the organic light emitting display device 10 may divide one frame into a plurality of sub-frames having different a temporal magnification, and apply a constant on-voltage or off-voltage to the plurality of sub-frames. Hereinafter, this will be described in more detail with reference to FIG. 3.

FIG. 3 is a schematic diagram illustrating a plurality of sub-frames.

Referring to FIG. 3, a first frame period 1F may be divided into a plurality of sub-frame periods SF1 to SF6. Here, the first frame period 1F may be a period in which all pixels PX of the display unit 110 display one image. The number of sub-frames is not limited to that as illustrated in the drawing. In some embodiments, the number of sub-frames may be 8 or more.

Each of the plurality of sub-frame periods SF1 to SF6 may include an address period Ta and a sustain period Ts. The address period Ta may be time required to input data values to all pixels in each of the plurality of sub-frame periods. That is, the address period Ta may be a period in which data voltages are applied according to the scan signals. The sustain period Ts may be a period in which the organic light emitting element EM is made to emit light. That is, the sustain period Ts may be a period in which corresponding data voltages are charged in the first capacitor C1, and at this time, the second power voltage ELVSS increases, and the electric potential may not be great enough to cause the organic light emitting element EM to emit light. The data voltages charged in the first capacitor C1 in the sustain period Ts may be applied to the gate terminal of the first thin film transistor Tr1, and at this time, the second power voltage ELVSS decreases, which may cause the electric potential to be great enough to cause the organic light emitting element EM to emit light. That is, the organic light emitting element EM may emit light according to the current that is generated to correspond to the electric potential difference between the data voltage of the gate terminal and the first power voltage ELVDD. However, if the data voltage becomes the off-voltage, the organic light emitting element EM does not emit light.

Here, the plurality of divided sub-frame periods SF1 to SF6 may differ from each other. That is, the light emitting times of the plurality of sub-frames may be different from each other in the ratio of 2̂n. For example, the first sustain period Ts1 and the second sustain period Ts2 may be 2⁵T and 2⁴T (where, T is an integer that is larger than 0), and the length ratio of the respective sustain periods Ts1 to Ts6 may be 2⁶:2⁵:2⁴:2³:2²:2:1. That is, the ratio of the above-described periods may be decreased with the flow of time, but is not limited thereto. The ratio of the periods may be set in the opposite manner to that as described above. According to the organic light emitting display device according to this embodiment, the gradations may be expressed on the basis of the sum of the light emitting times of the plurality of sub-frames. Here, the gradation in one frame may be based on a value that is obtained by multiplying the sustain periods Ts1 to Ts6 by data voltages applied to the respective sustain periods Ts1 to Ts6 and adding the multiplied values to each other. For example, if an off-voltage is applied in the second sustain period Ts2 and an on-voltage having a luminance value of Id1 is applied in the remaining sustain period, the gradation value that is expressed in one frame may be (128*Id1+32*Id1+16*Id1+8*Id+4*Id1+2*Id1+1*Id1)=191*Id1.

Here, according to the organic light emitting display device 10 according to some embodiments of the present invention, the driving unit PD may provide at least two on-voltages having different voltage values. That is, the organic light emitting elements EM of the display unit 110 can be provided with on-voltages having different voltage values, and thus more diverse gradations can be expressed. Hereinafter, this will be described in more detail with reference to FIGS. 4 to 6.

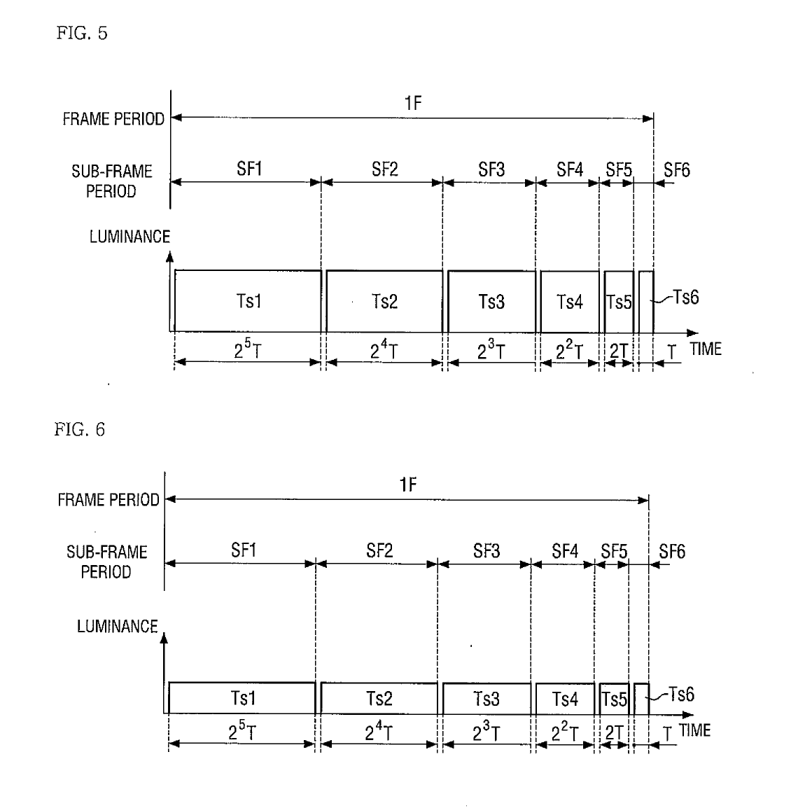

FIG. 4 is a graph illustrating the driving characteristics of a first thin film transistor. FIG. 5 is a schematic diagram illustrating the relationship between a first on-voltage and luminance of an organic light emitting element, and FIG. 6 is a schematic diagram illustrating the relationship between a second on-voltage and luminance of an organic light emitting element.

FIG. 4 is a graph illustrating the relationship between the amount of current (drain current Id) that flows through the channel of the first thin film transistor Tr1 and a gate voltage Vg that is applied to the gate terminal of the first thin film transistor Tr1. If the gate voltage Vg is gradually decreased to become lower than the threshold voltage Vth, the first thin film transistor Tr1 is turned on to operate in a saturation region. The saturation region may be a region in which the drain current Id is changed in proportion to the decrease of the gate voltage Vg. If the gate voltage Vg is further decreased, the first thin film transistor Tr1 can operate in a linear region in which the drain current Id is scarcely changed although the gate voltage Vg is decreased. As described above, the gate voltage Vg that is applied to the gate terminal is a data voltage that is transferred from the driving unit. The voltage that is higher than the threshold voltage Vth may be the off-voltage, and the voltage that is lower than the threshold voltage Vth may be the on-voltage. Here, the on-voltage may be a constant voltage having a constant voltage value.

The on-voltage may be a first on-voltage Vg1 or a second on-voltage Vg2, but is not limited thereto. In some embodiments, two or more on-voltages may be provided. The first on-voltage Vg1 may correspond to a linear region, and the second on-voltage Vg2 may correspond to a saturation region. That is, the first on-voltage Vg1 can provide a larger amount of drain current Id than that of the second on-voltage Vg2. Here, the amount of drain current Id1 that is provided by the first on-voltage Vg1 may be twice the amount of drain current Id2 that is provided by the second on-voltage Vg2. Because the amount of drain current Id is proportional to the amount of light emission of the organic light emitting element, the luminance obtained by the first on-voltage Vg1 may be twice the luminance obtained by the second on-voltage Vg2. That is, through the first on-voltage Vg1, the organic light emitting element may emit light with the luminance as illustrated in FIG. 5, while through the second on-voltage Vg2, the organic light emitting element may emit light with the luminance as illustrated in FIG. 6.

Accordingly, in the case where the first on-voltage Vg1 and the second on-voltage Vg2 are respectively supplied to the sub-frames having the same structure, different gradations can be expressed. That is, the organic light emitting display device 10 according to some embodiments may operate such that the gradation expression can be extended by providing a plurality of on-voltages. For example, if the first on-voltage Vg1 is applied to all sub-fields SF1 to SF6, the gradation may be 255*Id1, and if the second on-voltage Vg2 is applied to all sub-fields SF1 to SF6, the gradation may be 127.5*Id1. In this case, the second on-voltage Vg2 may express the gradation that is unable to be expressed by the first on-voltage Vg1. That is, the minimum control gradation of the first on-voltage Vg1 may correspond to the sixth sub-frame SF6 having the shortest light emitting time. That is, the minimum control gradation of the first on-voltage Vg1 may be Id1. In contrast, the minimum control gradation of the second on-voltage may be Id2 (=0.5*Id1) by the sixth sub-field SF6. That is, through the driving of the organic light emitting element by the second on-voltage Vg2, the gradation that is unable to be expressed by the second on-voltage Vg2 can be expressed by driving the organic light emitting element by the second on-voltage Vg2 even without the extension of the sub-frames, which may improve display quality.

Hereinafter, additional configuration of the organic light emitting display device 10 will be described.

Referring again to FIG. 1, the organic light emitting display device 10 may further include a power generation unit 150, and the driving unit DP of the organic light emitting display device 10 may include a scan driving unit 120, a data driving unit 130, and a timing control unit 140.

The scan driving unit 120 may receive a scan control signal SCS from the timing control unit 140. The scan driving unit 120 may output the plurality of scan signals S1 to Sn to correspond to the received scan control signal SCS and provide the plurality of scan signals S1 to Sn to the display unit 110. The plurality of scan signals S1 to Sn may be successively applied, but are not limited thereto. The scan driving unit 120 may select a pixel PX, to which the data voltage is to be provided, while supplying the plurality of scan signals S1 to Sn to the scan lines SL1 to SLn.

The data driving unit 130 may receive a data control signal DCS and vide data DATA from the timing control unit 140. The data driving unit 130 may output the plurality of data voltages D1 to Dm to the display unit 110 based on the data control signal DCS and the video data DATA.

The timing control unit 140 may receive an input of the timing control signal TCS from an external system and generate the scan control signal SCS for controlling the scan driving unit 120 and the data control signal DCS for controlling the data driving unit 130.

The voltage generation unit 150 may generate a gray reference voltage GV, the first power voltage ELVDD, the second power voltage ELVSS, and a gate on/off voltage (not illustrated) to provide the generated voltages to other configurations of the organic light emitting display device 10. Here, the voltage generation unit 150 may be a separate configuration from the driving unit DP, but is not limited thereto. In some embodiments, the voltage generation unit 150 may be configured to be included in the data driving unit 110 or the timing control unit 140.

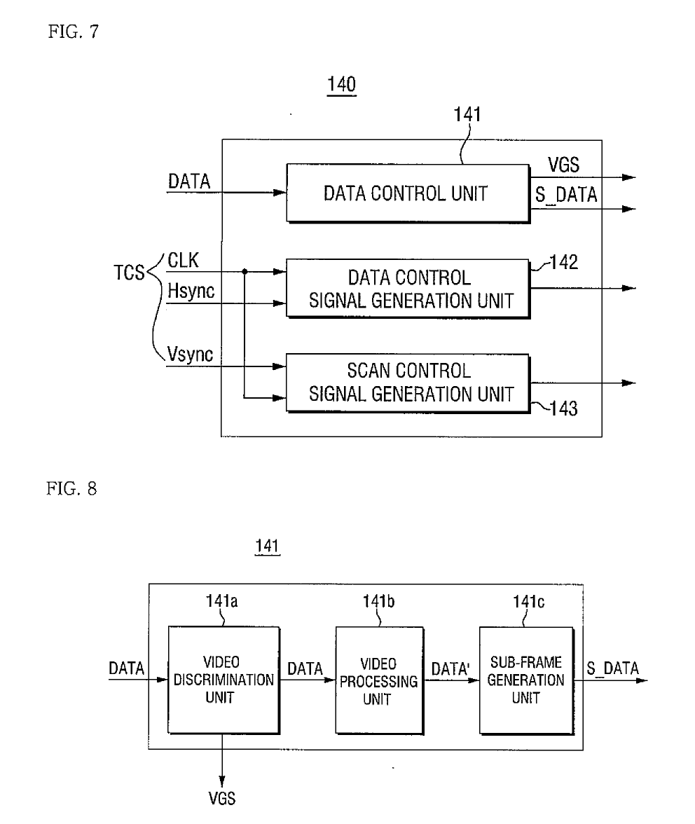

Hereinafter, the above-described configuration will be described in more detail with reference to FIGS. 7 to 10.

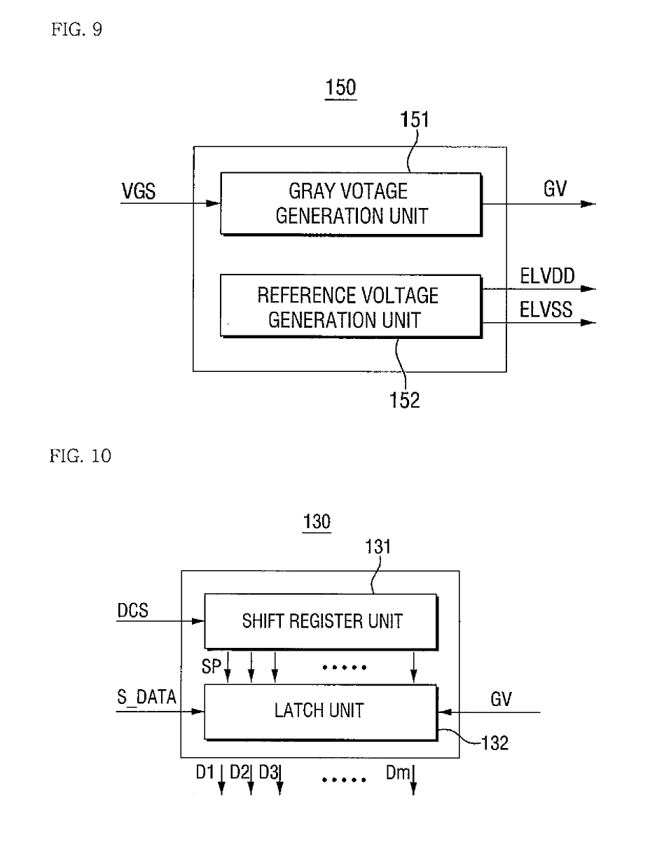

FIG. 7 is a block diagram of a timing control unit according to an embodiment of the present invention, and FIG. 8 is a block diagram of a data control unit according to an embodiment of the present invention. FIG. 9 is a block diagram of a voltage generation unit according to an embodiment of the present invention, and FIG. 10 is a block diagram of a data driving unit according to an embodiment of the present invention.

The timing control unit 140 may include a data control unit 141, a data control signal generation unit 142, and a scan control signal generation unit 143. The data control unit 141 may receive video data DATA and output a voltage control signal VCS and a sub-video data S_DATA. The video data DATA input to the data control unit 141 may be a digital signal that is converted from an analog signal. The data control unit 141 may analyze the video data DATA and output the voltage control signal VCS to the voltage generation unit 150 so that the voltage generation unit 150 generates the corresponding gray reference voltage. Further, the data control unit 141 may output the sub-video data S_DATA that is obtained by converting the video data DATA to correspond to the plurality of sub-frames to the data driving unit 130.

The data control signal generation unit 142 may receive a clock signal CLK and a horizontal sync signal Hsync, and output the data control signal DCS to the data driving unit 130. The data control signal DCS may be, for example, a source start pulse SSP and a source sampling clock SSC.

The scan control signal generation unit 143 may receive the clock signal CLK and a vertical sync signal Vsync, and output the scan control signal SCS to the scan driving unit 120. The scan control signal SCS may be a gate start pulse GSP and a gate sampling clock GSC.

For example, the data control unit 141 may include a video discrimination unit 141a, a video processing unit 141b, and a sub-frame generation unit 141c. The video discrimination unit 141a may select the gray reference voltage VCS through analysis of the input video data DATA. The video discrimination unit 141a may include at least one memory unit in which video data of two successive frames is stored, and compare the video data DATA of the current frame with the video data DATA of the next frame or compare the video data DATA of the current frame with the video data DATA of the previous frame to discriminate the video data DATA. For example, if it is determined that the video data DATA of the current frame is the video data DATA of which the gradation extension is required, the video discrimination unit 141a may output the voltage control signal VCS for adjusting the gray reference voltage GV so that the data driving unit 130 outputs the second on-voltage to the voltage generation unit 150. Further, if it is determined that the video data DATA of the current frame does not require the gradation extension, the video discrimination unit 141a may output the voltage control signal VCS for adjusting the gray reference voltage GV so that the data driving unit 130 outputs the first on-voltage to the voltage generation unit 150.

The video processing unit 141b may correct an RGB signal of the input video data DATA and output the corrected video data DATA′ to the sub-frame generation unit 141c. The video processing unit 141b may correct a gamma value of the video data DATA in consideration of the luminance characteristics of the organic light emitting display device. Further, the video processing unit 141b may adjust expressiveness of the gradation value by selecting the gradation to be used with respect to the gamma-corrected RGB signal using any one of truncation, random E/D, normal E/D, and dither, and generating the gradation between the selected gradations using the selected gradation to output the corrected video data DATA′.

The sub-frame generation unit 141c may generate the sub-video data S_DATA through mapping along a plurality of sub-fields based on the corrected video data DATA′. The sub-frame generation unit 141c may output the sub-video data S_DATA to the data driving unit 130.

The voltage generation unit 150 may include a gray voltage generation unit 151 and a reference voltage generation unit 152. In some embodiments, the gray voltage generation unit 151 and the reference voltage generation unit 152 are considered as one configuration, but are not limited thereto. The gray voltage generation unit 151 and the reference voltage generation unit 152 may be independently configured. The gray voltage generation unit 151 may output the gray reference voltage GV to the data driving unit 130. Here, the gray reference voltage GV may be a constant voltage having a constant voltage value. The gray voltage generation unit 151 may output gray reference voltages GV having different voltage values according to the voltage control signal VCS that is applied from the timing control unit 140. For example, the gray voltage generation unit 151 may output the first gray reference voltage GV1 that corresponds to the first on-voltage or the second gray reference voltage GV2 that corresponds to the second on-voltage in accordance with the voltage control signal VCS. The reference voltage generation unit 152 may generate the first power voltage ELVDD that is provided to the first power line ELVDDL and the second power voltage ELVDD that is coupled to the other terminal of the organic light emitting element EM. Further, the reference voltage generation unit 152 may output a scan on-voltage and a scan off-voltage of the scan signal.

The data driving unit 130 may include a shift register unit 131 and a latch unit 132. The shift register unit 131 may receive the data control signal DCS and successively supply the sampling pulses SP to the latch unit 132 in accordance with the data control signal DCS.

The latch unit 132 may receive the sub-video data S_DATA, the gray reference voltage GV, and the sampling pulses SP. The latch unit 132 may successively store the sub-video data S_DATA in response to the sampling pulses SP that are successively supplied from the shift register unit 131. The latch unit 132 may include a plurality of sampling latches to store a plurality of pieces of sub-video data S_DATA. The latch unit 132 may modify the stored sub-video data S_DATA corresponding to the voltage levels of the gray reference voltage GV and output a plurality of data voltages D1 to Dm. The gray reference voltage GV provided as described above may be the first gray reference voltage GV1 or the second gray reference voltage GV2 having a different voltage level, and the data voltage generated accordingly may be the first on-voltage or the second on-voltage having a different voltage level. The organic light emitting element EM of the display unit 110 can emit light corresponding to the first on-voltage or the second on-voltage, and thus more diverse gradation expressions may be possible.

Hereinafter, an organic light emitting display device according to another embodiment of the present invention will be described.

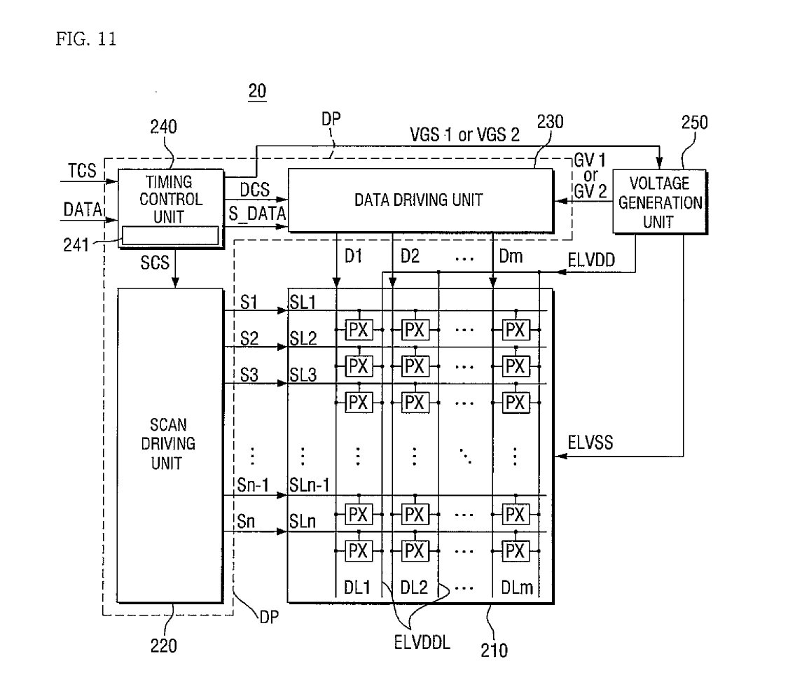

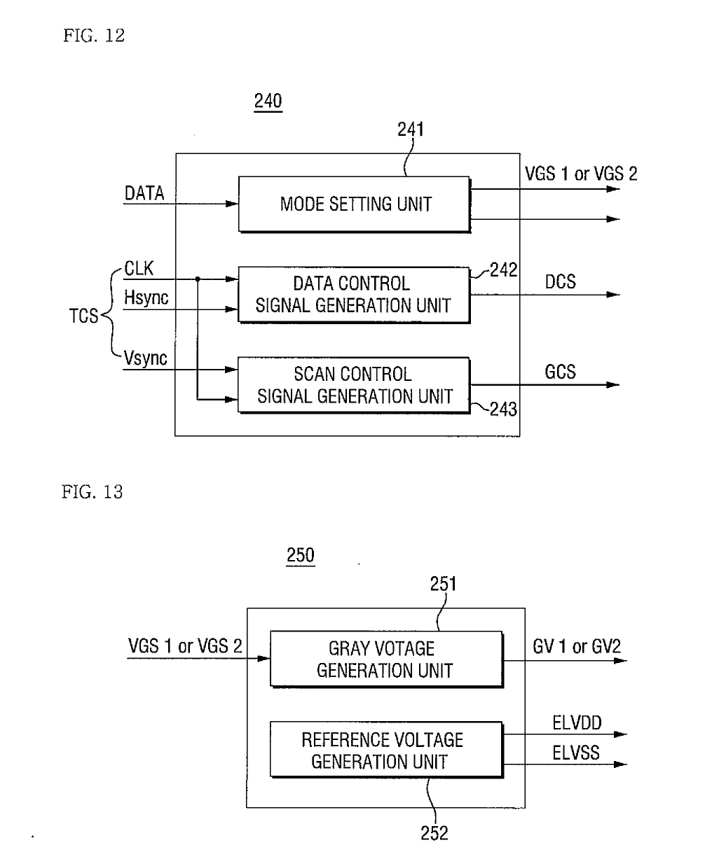

FIG. 11 is a block diagram of an organic light emitting display device according to another embodiment of the present invention. FIG. 12 is a block diagram of a timing control unit according to another embodiment of the present invention, and FIG. 13 is a block diagram of a voltage generation unit according to another embodiment of the present invention.

Referring to FIGS. 11 to 13, an organic light emitting display device 20 according to another embodiment of the present invention may include a timing control unit 240 that includes a mode setting unit 241. The mode setting unit 241 may determine an operation mode of the organic light emitting display device 20 through analysis of input video data DATA. For example, the mode setting unit 241 may discriminate the operation mode of the organic light emitting display device as a first mode or a second mode according to the video data DATA.

If it is determined that the operation mode is the first mode through analysis of the video data DATA, the mode setting unit 241 may output a first mode signal VCS1 to a voltage generation unit 250, while if it is determined that the operation mode is the second mode, the mode setting unit 241 may output a second mode signal VCS2 to the voltage generation unit 250.

A gray voltage generation unit 251 of the voltage generation unit 250 may output a first gray reference voltage GV1 to a data driving unit 230 of a driving unit DP in accordance with the first mode signal VCS1, and output a second gray reference voltage GV2 in accordance with the second mode signal VCS2.

The data driving unit 230 may output a first on-voltage corresponding to the first gray reference voltage GV1 and output a second on-voltage corresponding to the second gray reference voltage GV2.

The driving unit DP of the organic light emitting display device 20 may provide the first on-voltage that corresponds to a first luminance to a display unit 210 in the first mode, and provide the second on-voltage that corresponds to a second luminance that is relatively lower than the first luminance to the display unit 210 in the second mode. Here, the first luminance may be twice the second luminance, but is not limited thereto. As described above according to an embodiment of the present invention, the driving of the organic light emitting display device by the second on-voltage can express gradations that are not implemented through the driving by the first on-voltage, and thus expressible gradations can be extended. Further, the driving unit DP may provide the second on-voltage to the display unit 210 in the second mode, and then provide the first on-voltage again to the display unit 210 to express higher gradations. That is, the driving unit DP may alternately apply the second on-voltage and the first on-voltage in the second mode, which may result in relatively higher display quality.

Here, the first mode may correspond to normal driving, and the second mode may correspond to 3D driving or dual-view driving. That is, the second mode may be applied in the 3D driving or dual-view driving in which the gradation expression may be insufficient, and thus the gradation can be extended without extension of sub-frames to provide high display quality. The organic light emitting display device 20 according to another embodiment of the present invention can set the driving mode according to the input video data, and in the case of the driving in which the gradation expression may be insufficient, it can supplement the insufficient gradation expression by the first on-voltage through providing of the second on-voltage to the display unit to provide more improved display quality.

Because other configurations included in the organic light emitting display device 20 are the same or similar as explanation of those included in the organic light emitting display device 10 of FIGS. 1 to 10, some duplicate explanation thereof will be omitted.

Hereinafter, a method for driving an organic light emitting display device according to an embodiment of the present invention will be described.

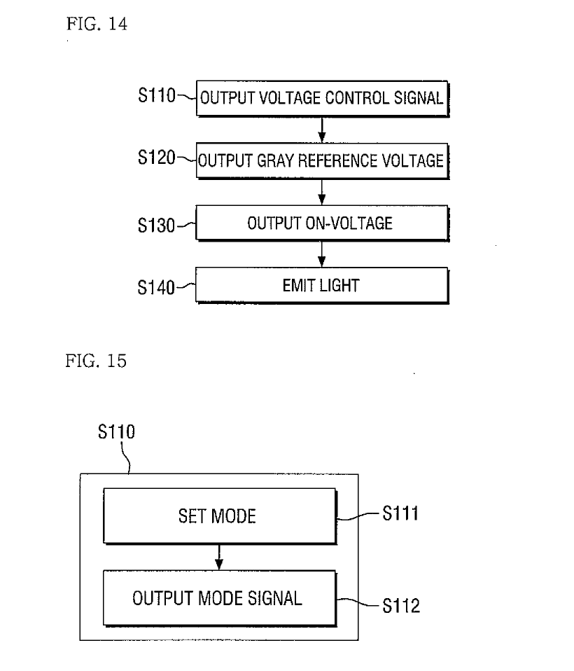

FIG. 14 is a flowchart of a method for driving an organic light emitting display device according to an embodiment of the present invention.

A method for driving an organic light emitting display device according to this embodiment may correspond to digital drive type in which one frame is divided into a plurality of sub-frames, and gradations are expressed on the basis of the sum of light emitting times of the plurality of sub-frames. The method for driving an organic light emitting display device includes outputting a voltage control signal (S110), outputting a gradation reference signal (S120), outputting an on-voltage (S130), and emitting light through organic light emitting elements (S140).

First, a voltage control signal is output (S110).

The voltage control signal VCS may be output from a timing control unit 140 to a voltage generation unit 150. The timing control unit 140 may analyze input video data DATA, and if it is determined that there are many gradation expressions, the timing control unit 140 may adjust the voltage control signal VCS to output the adjusted voltage control signal to the voltage generation unit 150. A data control unit 141 may include a video discrimination unit 141a. The video discrimination unit 141a may select the gray reference voltage VCS through analysis of the input video data DATA. The video discrimination unit 141a may include at least one memory unit in which video data DATA of two successive frames is stored, and compare the video data DATA of the current frame with the video data DATA of the next frame or compare the video data DATA of the current frame with the video data DATA of the previous frame to discriminate the video data DATA. For example, if it is determined that the video data DATA of the current frame is the video data DATA of which the gradation extension is required, the video discrimination unit 141a may output the voltage control signal VCS for adjusting a gray reference voltage GV so that the data driving unit 130 outputs the second on-voltage to the voltage generation unit 150. Further, if it is determined that the video data DATA of the current frame does not require the gradation extension, the video discrimination unit 141a may output the voltage control signal VCS for adjusting the gray reference voltage GV so that the data driving unit 130 outputs the first on-voltage to the voltage generation unit 150. Here, the first luminance with which organic light emitting elements emit light by the first on-voltage may be twice the second luminance with which the organic light emitting elements emit light by the second on-voltage. Further, the timing control unit 140 may correct a gamma value of the video data DATA and output sub-video data S_DATA mapped to correspond to sub-frames to the data driving unit 130. Further, the timing control unit 140 may receive a timing control signal TCS, generate a scan control signal SCS for controlling a scan driving unit 120 and a data control signal DCS for controlling the data driving unit 130, and provide the scan control signal SCS and the data control signal DCS to the scan driving unit 120 and the data driving unit 130, respectively.

Then, a gray reference voltage is output (S120).

The voltage generation unit 150 may include a gray voltage generation unit 151 and a reference voltage generation unit 152, and the gray voltage generation unit 151 may receive the voltage control signal VCS. The gray voltage generation unit 151 may output the gray reference voltage GV having a different voltage value according to the voltage control signal VCS applied from the timing control unit 140. For example, the gray voltage generation unit 151 may output the first gray reference voltage GV1 that corresponds to the first on-voltage or the second gray reference voltage GV2 that corresponds to the second on-voltage in accordance with the voltage control signal VCS. Here, the gray reference voltage GV may be a constant voltage having a constant voltage value. The gray voltage generation unit 151 may output the gray reference voltage GV to the data driving unit 130.

The on-voltage is output on the basis of the gray reference voltage GV (S130).

The data driving unit 130 may modify the sub-video data S_DATA provided from the timing control unit 140 to correspond to the voltage levels of the gray reference voltage GV and output the on-voltage. That is, if the gray reference voltage GV is the first gray reference voltage GV1, the first on-voltage may be generated, while if the gray reference voltage GV is the second gray reference voltage GV2, the second on-voltage may be generated. The generated on-voltage may be output to organic light emitting elements EM of a display unit 110 through a plurality of data lines DL1 to DLm.

The organic light emitting element emits light corresponding to the on-voltage (S140).

The organic light emitting element EM of the display unit 110 may emit light corresponding to the first on-voltage or the second on-voltage. As described above, the first luminance by the first on-voltage may be higher than the second luminance by the second on-voltage, and in some embodiments, the first luminance may be twice the second luminance. That is, if the second on-voltage is applied to the organic light emitting element EM, gradations that are not implemented by the first on-voltage can be expressed. That is, the gradations can be extended by the second on-voltage, and thus higher display quality can be provided.

That is, in the case of the organic light emitting display device according to an embodiment of the present invention, the first on-voltage and the second on-voltage having different voltage levels are output through changing the gray reference voltage according to the input data, and thus the gradation expression can be extended even without extending the number of sub-frames to provide more improved display quality.

Because explanation of other features of the method for driving the organic light emitting display device is the same as or similar to explanation of those included in the organic light emitting display device 10 of FIGS. 1 to 10, some duplicate explanation thereof will be omitted.

In some embodiments, the outputting the voltage control signal in the method for driving the organic light emitting display device may determine the driving mode of the organic light emitting display device through analysis of the input video data. This will be described in more detail with reference to FIG. 15.

FIG. 15 is a flowchart of a process of outputting a voltage control signal according to an embodiment of the present invention.

The outputting the voltage control signal (S110) may include setting a mode (S111) and outputting a mode signal (S112).

That is, the timing control unit 240 may discriminate a first mode and a second mode from each other according to the input video data, and set the first mode or the second mode (S111).

Accordingly, the timing control unit 240 may output a first mode signal VGS1 or a second mode signal VGS2 to the gray voltage generation unit 251 of the voltage generation unit 250 (S112).

The gray voltage generation unit 251 may output a first gamma reference voltage GV1 that corresponds to a first mode signal VGS1 and a second gamma reference voltage GV2 that corresponds to a second mode signal VGS2 to the data driving unit 230. The data driving unit 230 may provide the first on-voltage or the second on-voltage that correspond to the above-described gamma reference voltages to the organic light emitting element of the display unit 210 to cause the organic light emitting element to emit light.

Here, the first on-voltage that corresponds to the first luminance may be provided to the display unit 210 in the first mode, and the second on-voltage that corresponds to the second luminance that is relatively lower than the first luminance may be provided to the display unit 210 in the second mode. Here, the first luminance may be twice the second luminance, but is not limited thereto. The driving of the organic light emitting display device by the second on-voltage can express the gradations that are not implemented through the driving by the first on-voltage, and thus the gradation extension may become possible.

Here, the first mode may correspond to normal driving, and the second mode may correspond to 3D driving or dual-view driving. That is, the method for driving the organic light emitting display device according to this embodiment can set the second driving mode during the 3D driving or dual-view driving in which the gradation expression may be insufficient, and provide the gradation extension even without extension of the sub-frames to provide higher display quality.

Although example embodiments of the present invention have been described for illustrative purposes, those skilled in the art will appreciate that various modifications, additions and substitutions are possible, without departing from the scope and spirit of the invention as disclosed in the accompanying claims, and their equivalents.

What is claimed is:

1. An organic light emitting display device configured to divide one frame into a plurality of sub-frames and to express gradations based on a sum of light emitting times of the plurality of sub-frames, the organic light emitting display device comprising:
a driving unit configured to provide at least two on-voltages having different voltage values; and
a display unit comprising a plurality of organic light emitting elements configured to be driven by the on-voltages.

2. The organic light emitting display device of claim 1, wherein the driving unit is configured to provide:
a first on-voltage configured to cause the organic light emitting elements to emit light with a first luminance; and
a second on-voltage configured to cause the organic light emitting elements to emit light with a second luminance lower than the first luminance.

3. The organic light emitting display device of claim 2, wherein the first luminance is twice the second luminance.

4. The organic light emitting display device of claim 2, wherein the first on-voltage is a gate voltage that corresponds to a saturation region of a thin film transistor, and the second on-voltage is a gate voltage that corresponds to a linear region of the thin film transistor.

5. The organic light emitting display device of claim 2, wherein a minimum control gradation of the first on-voltage is twice a minimum control gradation of the second on-voltage.

6. The organic light emitting display device of claim 1, wherein the organic light emitting element comprises a first thin film transistor configured to drive the organic light emitting element and a second thin film transistor configured to control the first thin film transistor, and wherein the on-voltage is applied to a gate terminal of the first thin film transistor through the second thin film transistor.

7. The organic light emitting display device of claim 1, wherein the light emitting times of the plurality of sub-frames are different from each other in the ratio of 2̂n.

8. The organic light emitting display device of claim 1, wherein the driving unit comprises a data driving unit configured to provide the on-voltage to the display unit, a scan driving unit configured to provide a scan signal to the display unit, and a timing control unit configured to control the data driving unit and the scan driving unit, and
wherein the organic light emitting display device further comprises a voltage generation unit configured to provide a gray reference voltage to the data driving unit and to provide a first voltage and a second voltage to the display unit.

9. The organic light emitting display device of claim 8, wherein the timing control unit further comprises a data control unit configured to analyze video data, to output a voltage control signal to the voltage generation unit, and to control the gray reference voltage, and
wherein the data driving unit is configured to determine a voltage value of the on-voltage corresponding to the gray reference voltage.

10. An organic light emitting display device configured to divide one frame into a plurality of sub-frames and to express gradations based on a sum of light emitting times of the plurality of sub-frames, the organic light emitting display device comprising:
a driving unit configured to provide at least two on-voltages having different voltage values according to input video data; and
a display unit comprising a plurality of organic light emitting elements that are configured to be driven by the on-voltages.

11. The organic light emitting display device of claim 10, wherein the driving unit comprises a mode setting unit configured to discriminate a first mode from a second mode according to the video data, and
wherein the driving unit is configured to provide a first on-voltage corresponding to a first luminance in the first mode, and to provide a second on-voltage corresponding to a second luminance lower than the first luminance in the second mode.

12. The organic light emitting display device of claim 11, wherein the first mode corresponds to normal driving and the second mode corresponds to 3D driving or dual-view driving.

13. The organic light emitting display device of claim 11, further comprising a voltage generation unit configured to provide a gray reference voltage to the driving unit and to provide a first voltage and a second voltage to the display unit.

14. The organic light emitting display device of claim 13, wherein the mode setting unit is configured to provide a first mode signal or a second mode signal to the voltage generation unit, and the voltage generation unit is configured to output a first gray reference voltage corresponding to the first mode signal to the driving unit and to output a second gray reference voltage corresponding to the second mode signal to the driving unit.

15. The organic light emitting display device of claim 11, wherein the first luminance is twice the second luminance.

16. A method for driving an organic light emitting display device, the organic light emitting display device configured to divide one frame into a plurality of sub-frames and to express gradations based on a sum of light emitting times of the plurality of sub-frames, the method comprising:
analyzing video data;
outputting a voltage control signal;
outputting a gray reference voltage corresponding to the voltage control signal;
outputting an on-voltage that corresponds to the vide data based on the gray reference voltage; and
emitting light corresponding to the on-voltage by organic light emitting elements,
wherein the on-voltage has at least two different voltage values.

17. The method of claim 16, wherein the on-voltage comprises a first on-voltage configured to cause the organic light emitting elements to emit light with a first luminance and a second on-voltage configured to cause the organic light emitting elements to emit light with a second luminance lower than the first luminance.

18. The method of claim 16, wherein the outputting of the voltage control signal comprises setting a first mode and a second mode that are discriminated from each other according to the video data, and outputting a first mode signal or a second mode signal corresponding to the set mode.

19. The method of claim 18, wherein the outputting of the gray reference voltage comprises outputting a first gray reference voltage corresponding to the first mode signal, and outputting a second gray reference voltage corresponding to the second mode signal.

20. The method of claim 18, wherein the outputting of the on-voltage comprises outputting a first on-voltage corresponding to the first mode, and outputting a second on-voltage corresponding to the second mode.
